(19) United States
(12) Patent Application Publication
(10) Pub. No.: US 2009/0160386 A1
(43) Pub. Date: Jun. 25, 2009

(54) ELECTRIC DRIVE DEVICE CONTROL SYSTEM AND METHOD

(75) Inventors: Masashi Honda, Okazaki-city (JP); Akira Takagi, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/269,078

(22) Filed: Nov. 12, 2008

(30) Foreign Application Priority Data
Dec. 25, 2007 (JP) 2007-332177
Jun. 30, 2008 (JP) 2008-170865

(51) Int. Cl. H02P 7/00

(52) U.S. Cl. 318/434

(57) ABSTRACT

An electric drive device control system includes an electric drive device and an electric control unit. The electric control unit stores a control-side correction current for compensating for a current deviation of the electric control unit and a drive-side correction current for compensating for an operation deviation of the electric drive device. The electric control unit updates the drive-side correction current to a new drive-side correction current, which is specific to a new electric drive device, when the electric drive device is replaced with the new electric drive device. The electric control unit also updates the control-side correction current to a new control-side correction current, when the electric control unit is replaced with the new electric control unit.

### CROSS REFERENCE TO RELATED APPLICATION

This application is based on and incorporates herein by reference Japanese Patent Applications No. 2007-332177 filed on Dec. 25, 2007 and No. 2008-170865 filed on Jun. 30, 2008.

### FIELD OF THE INVENTION

The present invention relates to an electric drive device control system and method, the system including an electric drive device for operating with an electric power supplied thereto and an electric control unit for controlling the electric power supplied to the electric drive device. For instance, the present invention is applicable to a hydraulic pressure control system for a vehicle automatic transmission, which includes an electromagnetic valve as an electric drive device and an electric control unit for electrically controlling the electromagnetic valve.

### BACKGROUND OF THE INVENTION

It is a conventional practice to measure deviation of an actual operation of an electric drive device from a designed operation of the same before it is shipped with an electric control unit as an electric drive device control system. Specifically, the deviation is measured by actually operating the electric drive device with an electric current supplied by the electric control unit. Based on the measured deviation, a system correction current (current value ΔIc) required to compensate for the deviation is calculated and stored in the electronic control unit. Thus, after the shipment of the electric drive device control system, the electric control unit continuously corrects the electric current supplied to the electric drive device by the stored system correction current ΔIc.

The system correction current ΔIc is specific to each electric drive device control system, because it corresponds to both deviations of operation characteristics of the electric drive device itself and the electric control unit itself. Therefore, even if either one of the electric drive device or the electric control unit is replaced with a new one to eliminate failure of the electric drive device control system, the operation deviation of the control system cannot be compensated appropriately. As a result, it is not possible to replace only a part of the control system and is required to replace many component parts. Thus, maintenance of the control system requires increased repair work and cost.

This problem is described in more detail with reference to a hydraulic pressure control system for a vehicle automatic transmission as an example (U.S. Pat. No. 5,377,111, JP 5-215206A).

The hydraulic pressure control system includes a hydraulic pressure fluid supply device, in which an electromagnetic valve is mounted, and an electric transmission control unit (TCU) for controlling the electromagnetic valve. After manufacture and before shipment of the control system, a deviation of a hydraulic pressure (operation deviation), which is caused when the electromagnetic valve is controlled by the TCU, is measured. A system correction current ΔIc, which is a current value required to compensate for the measured deviation, is stored in the TCU. After the control system is operated later, the TCU thus corrects an electric current (current value Is) supplied to the electromagnetic valve by the stored system correction current ΔIs each time the TCU controls the electromagnetic valve.

The system correction current ΔIc corresponds to the deviation in the operation characteristics of the TCU (deviation of an actual current value relative to a command current value) and the deviation in the operation characteristics of the electromagnetic valve (deviation of an output hydraulic pressure relative to the actual current value), and hence is specific to the hydraulic pressure control system. If the electromagnetic valve or the TCU is replaced for eliminating the failure thereby to fix the control system, the deviation in the hydraulic pressure in the control system cannot be compensated appropriately. Thus, not only the component part that fails to operate properly but also other associated component parts must also be replaced, resulting in increase in repair work and cost.

### SUMMARY OF THE INVENTION

It is therefore an object of the present invention to provide an electric drive device control system and method, which allows replacement of only an electric drive device or an electric control unit while making it possible to compensate for a deviation of the control system without replacement of many component parts.

According to one aspect of an electric drive device control system and method, an electric drive device control system includes an electric drive device operable with an electric power applied thereto, and an electric control unit for the electric drive device. The control system is tested before shipment to measure a system operation deviation from a predetermined system operation characteristics and determine a system correction value required to eliminate the measured system operation deviation. Further, either the electric drive device or the electric control unit is tested before shipment to measure an operation deviation of the electric drive device or the electric control unit from a predetermined operation characteristics. A first correction value required to eliminate the measured operation deviation of the tested electric drive device or electric control unit is determined. A second correction value required to eliminate an operation deviation of the untested electric drive device or electric control unit is determined by subtracting the first correction value from the system correction value. The first correction value and the second correction value are stored separately in the electric control unit, so that the electric control unit uses them to correct the electric power applied to the electric drive device by the electric control unit. When the electric drive device or the electric control unit are replaced with a new one, the corresponding one of the first correction value and the second correction value is updated to a new correction value, which is for eliminating an operation deviation of the new one.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a vehicle automatic transmission control system including a hydraulic pressure fluid supply device and a TCU;

FIG. 2A is a characteristic diagram showing a relation of an output hydraulic pressure value of the fluid supply device relative to a command current value of the TCU;

FIG. 2B is a characteristic diagram showing a relation of an actual current value of the fluid supply unit relative to the command current value of the TCU; and

FIG. 2C is a characteristic diagram showing a relation of the output hydraulic pressure value of the fluid supply device relative to the actual current value of the fluid supply device.

### DETAILED DESCRIPTION OF THE PREFERRED EMBODIMENT

### First Embodiment

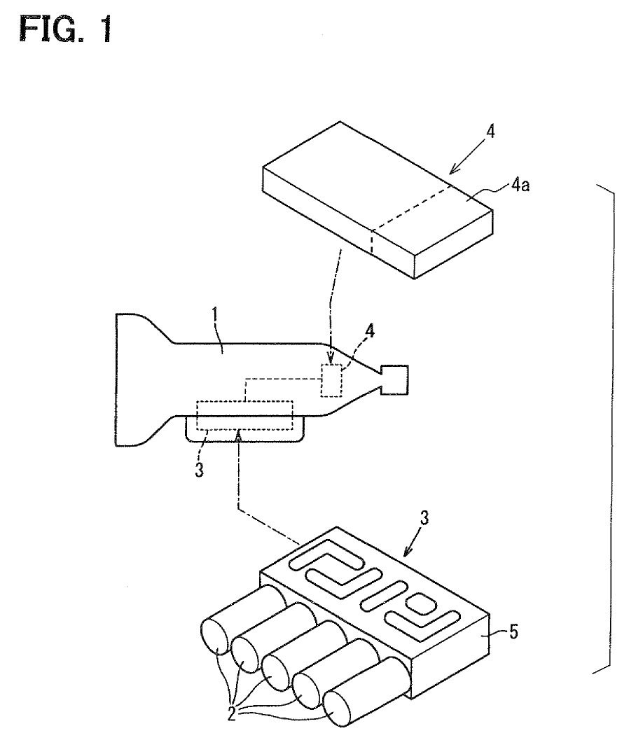

Referring first to FIG. 1, an electric drive device control system is implemented as a hydraulic pressure control system for a vehicle automatic transmission 1. The automatic transmission 1 operates to change a ratio of rotation of vehicle wheels relative to rotation of an engine, a direction of rotation of the wheels, engagement/disengagement of a lock-up clutch of a torque converter, and the like. For these operations, the automatic transmission 1 includes a plurality of friction engagement devices (multiple disk clutch, multiple disk brake, etc.), which are controlled by the hydraulic pressure control system.

Each friction engagement device is constructed with friction members (multiple plates, etc.) and a hydraulic actuator, which engages and disengages the friction members. The hydraulic pressure supplied to the hydraulic actuator is controlled by the hydraulic pressure control system. The hydraulic pressure control system includes a hydraulic pressure fluid supply device 3 as an electric drive device, which includes a plurality of electromagnetic valves (solenoid valves) 2, and a transmission control unit (TCU) 4 as an electrical control unit. The TCU 4 is provided in the automatic transmission 1 and connected to control the on/off of the electromagnetic valves 2.

The fluid supply device 3 includes a valve body 5, and the electromagnetic valves 2 are coupled with the valve body 5. Thus, the hydraulic fluid passages in the valve body 5 are switched over to open or close by the electromagnetic valves 2.

The electromagnetic valve 2 may be a conventional device, in which a valve member (spool valve, ball valve, etc.) and an electromagnetic solenoid actuator for driving the valve member are combined. The electromagnetic valve 2 may be a direct control type, which directly controls hydraulic pressure of the hydraulic pressure actuator of the friction engagement device, or a pilot control type, which controls an independent valve that controls hydraulic pressure of the hydraulic pressure actuator of the friction engagement device.

The electromagnetic valve 2 may be a normally low (closed) type, which stops hydraulic pressure supply when deenergized, or a normally high (open) type, which supplies the hydraulic pressure when deenergized. The electromagnetic valve 2 causes the valve body 5 to supply the hydraulic pressure fluid in accordance with an actual electric current supplied thereto, whichever type the electromagnetic valve 2 is.

The TCU 4 includes a microcomputer, which is constructed with a CPU for executing control processing and calculation processing, memories (ROM, RAM, EEPROM) for storing control programs and data, a signal input circuit, a signal output circuit, a power supply circuit, and the like. The TCU 4 is programmed to control the energization (current supply) of each electromagnetic valve 2 by calculating a control amount (current supply amount) based on operation instruction signals generated by a vehicle driver and detection signals generated by vehicle travel condition detectors. The memories of the TCU 4 include an EEPROM 4a, which is rewritable and maintains data stored therein even if the power supply is interrupted.

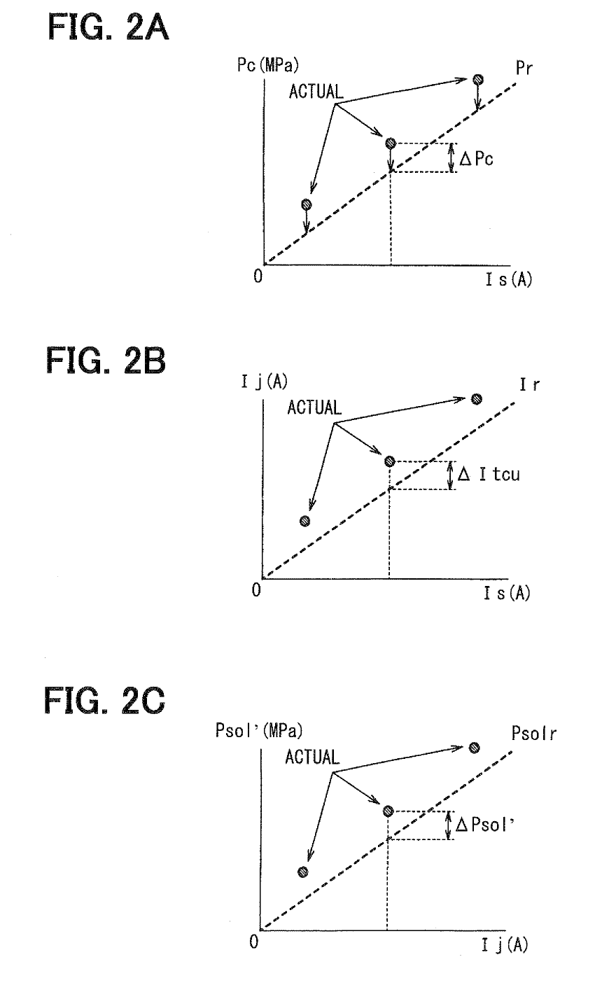

The hydraulic control system is tested after being manufactured and before shipped, so that the fluid supply device 3 may supply the hydraulic pressure fluid to each friction engagement members in accordance with command values calculated by the TCU 4. In the hydraulic pressure control system, before shipment, the TCU 4 is caused by a testing apparatus (not shown) to calculate a command current (current value Is) to be applied to each electromagnetic valve 2. The control system is designed and manufactured to supply fluid of hydraulic pressure (pressure value Pc) as shown by a broken line in FIG. 2A. The broken line in FIG. 2A indicates a reference characteristics (pressure value) to be attained when the command current Is is applied. The hydraulic pressure Pc actually supplied with the command current Is is measured and compared with a reference pressure (broken line) Pr to calculate a deviation ΔPc of the actual hydraulic pressure Pc from the reference pressure Pr with respect to each electromagnetic valve 2.

The TCU 4 is programmed to compensate for the deviation ΔPc, which is caused when the command current Is is calculated for the electromagnetic valve 2, by storing in its EEPROM 4a a system correction current ΔIc. This system correction current ΔIc is predetermined to eliminate the deviation ΔPc with respect to each electromagnetic valve 2, that is, to eliminate deviations of the fluid supply device 3 (electromagnetic valve 2) and the TCU 4.

Specifically, the TCU 4 is programmed to correct the command current Is calculated for the electromagnetic valve 2 by adding or subtracting the correction current ΔIc stored in the EEPROM 4a after the shipment thereby to match the actual hydraulic pressure Pc to the reference pressure Pr.

Before the shipment, the TCU 4 is also caused by the testing apparatus to calculate the command current Is for the electromagnetic valve 2, and an actual current Ij supplied to the electromagnetic valve 2 is measured. By comparing the actual current Ij with a reference current Ir corresponding to the command current Is and indicated by a broken line in FIG. 2B, a current deviation (current value ΔItcu) between the two currents is calculated. This deviation ΔItcu is stored as a control-side correction current in the EEPROM 4a.

After calculating the system correction current ΔIc for compensating for the pressure deviation ΔPc and the control-side correction current ΔItcu for compensating for the current deviation, the TCU 4 subtracts the control-side correction current ΔItcu from the system correction current ΔIc with respect to each electromagnetic valve 2 and stores a result as a drive-side correction current ΔIsol (=ΔIc−ΔItcu) of each electromagnetic valve 2 in the EEPROM 4a. The EEPROM 4a of the TCU 4 thus stores separately the control-side correction current ΔItcu for eliminating the deviation specific to the TCU 4 and the drive-side correction current (ΔIsol) for eliminating the deviation specific to the electromagnetic valve 2.

When the electromagnetic valve (old one) 2 is replaced with another electromagnetic valve (new one) 2, the TCU 4 updates the stored drive-side correction current ΔIsol in the EEPROM 4a by replacing the correction current (ΔIsol) of the old one with a drive-side correction current (ΔIsol′) of a new one. Thus, the old system correction current ΔIc (=ΔItcu+ΔIsol) before replacement is changed to a new system correction current ΔIc′ (=ΔItcu+ΔIsol′), so that the command current Is calculated for the electromagnetic valve 2 is corrected by the updated system correction current ΔIc′ after the replacement of the electromagnetic valve 2. As a result, the fluid supply device 3 supplies hydraulic pressure, which has no deviation ΔPc relative to the calculated command current Is.

As described above, the fluid supply device 3 is a combination of the electromagnetic valves 2 and the valve body 5. The electromagnetic valves 2 may be replaced in different manners, that is, (i) replaced separately from the valve body 5, or (ii) replaced as a part of full replacement of the fluid supply device 3 (including all electromagnetic valves 2 and valve body 5).

The TCU 4 may be replaced with a new one, in which (iii) a new control-side correction current ΔItcu′ specific to the new TCU 4 is stored in place of the old correction current ΔItcu specific to the old TCU 4 so that the system correction current ΔIc′ (=ΔItcu′+Isol) may be used to correct the command current Is.

The details of the respective cases (i) to (iii) are described in detail below. It is assumed that each electromagnetic valve 2 and each TCU 4 will be imparted with respective data codes, which indicate respective current correction values to be read into the TCU 4.

In the case (i), in which the electromagnetic valve 2 is replaced separately from the TCU 4, the electromagnetic valve (new one) 2 is supplied with an actual current Ij by the testing apparatus before shipment and a deviation ΔPsol′ of an output hydraulic pressure Psol′ from a reference hydraulic pressure Psolr (broken line in FIG. 2C) is calculated. This deviation ΔPsol′ is converted into a corresponding drive-side correction current ΔIsol′, and the correction current ΔIsol′ is imparted in a data code to the electromagnetic valve 2 thus tested.

The data code may be a quick-response (QR) code, bar code or any other conventional readable codes, and imparted by baking or die-stamping the surface of the electromagnetic valve 2.

The TCU 4 is configured to be connectable to a scanner, which reads the data code imparted on the electromagnetic valve 2. When the electromagnetic valve 2 is changed from the old one to the new one, the data code of the new electromagnetic valve 2 is read by the scanner and the correction current ΔIsol′ is stored in the EEPROM 4a of the TCU 4 in place of the correction current ΔIsol of the old electromagnetic valve 2. The TCU 4 stores the control-side correction current ΔItcu and each drive-side correction current ΔIsol′ in the EEPROM 4a separately one another.

Thus, the correction of total current supplied to the electromagnetic valve is changed from ΔIc=ΔItcu+ΔIsol for the old electromagnetic valve 2 to ΔIc′=ΔItcu+ΔIsol′ for the new electromagnetic valve 2. As a result, even if only a part of the electromagnetic valves 2 is replaced, the command current Is for each electromagnetic valve 2 can be corrected appropriately by using the updated correction current ΔIc′.

In the case (ii), in which the fluid supply device 3 including all the electromagnetic valves 2 and the valve body 5 is replaced with a new one, data codes of the correction currents ΔIsol′ of all the electromagnetic valves 2 are imparted to the fluid supply device 3 to be read by the TCU 4 and stored in the EEPROM 4a.

When the fluid supply device 3 is changed from the old one to the new one, the new fluid supply device 3 is tested by the testing apparatus before shipment. Specifically, in the same manner as described in case (i), each of the new electromagnetic valves 2 is tested by supplying the actual current Ij, and the data code indicative of the drive-side correction current ΔIsol′ for compensating for or eliminating the measured deviation ΔPsol′ is imparted to the valve body 5.

When the fluid supply device 3 is fully replaced, the data codes imparted on the new fluid supply device 3 are read by the TCU 4 by the scanner and the drive-side correction currents ΔIsol′ indicated by the data codes are stored in the EEPROM 4a in place of the drive-side correction currents ΔIsol of the old fluid supply device 3. Thus, the TCU 4 stores in the EEPROM 4a both the control-side correction current ΔItcu and the drive-side correction currents ΔIsol′ separately.

Thus, the correction of current supplied to each electromagnetic valve 2 is changed in the same manner as in the case (i). As a result, even if only the fluid supply device 3 itself is replaced fully, the command currents Is for the new electromagnetic valves 2 can be corrected appropriately by using the updated system correction currents ΔIc′.

In the case (iii), in which the TCU 4 is replaced with a new one, data code of the drive-side correction current ΔIsol of each electromagnetic valve 2 need be imparted to the corresponding electromagnetic valve 2 or to the fluid supply device 3 so that they may be read in by a new TCU 4.

When the TCU 4 is changed from the old one to the new one, the new TCU 4 is tested by the testing apparatus in the same manner as described above in reference to FIG. 2B, and a data code indicative of the control-side correction value corresponding to the deviation ΔItcu between the command current Is and the actual current Ij is stored in an EEPROM 4a of the new TCU 4.

When the new TCU 4 is installed in place of the old TCU 4 without replacing the electromagnetic valves 2, the new TCU 4 reads in the data code indicating the drive-side correction current ΔIsol of each electromagnetic valve 2 by the scanner and stores them in its EEPROM 4a.

After the new TCU 4 is operatively coupled to the fluid supply device 3, the system correction current for the electromagnetic valve 2 is changed from the old system correction current ΔIc=ΔItcu+ΔIsol to ΔIc′=ΔItcu′+ΔIsol. Even if only the TCU 4 is thus replaced, the command current Is calculated for each electromagnetic valve 2 can be corrected by the corresponding system correction current ΔIc′ and compensate for the operation deviation of the system appropriately.

According to the first embodiment, even if only the fluid supply device 3 (specifically electromagnetic valve 2) or the TCU 4 is replaced, the output pressure of the hydraulic pressure control system can be appropriately corrected and the operation deviation specific to the hydraulic pressure control system can be compensated.

Since the electromagnetic valve 2 or the TCU 4 can be replaced singly without requiring replacement of both parts, the number of parts to be replaced can be reduced and replacement work and costs can be reduced.

Since the correction values are stored in a memory (e.g., EEPROM) of the TCU 4, no new memory is necessitated. Since the TCU 4 is not limited in installation, the TCU 4 can be designed with high freedom. If the TCU 4 is installed inside the automatic transmission 1, it is not necessary to protect it from exhaust heat, which will normally necessitate heat insulation for a TCU 4 when installed on a side part of the automatic transmission 1.

### Second Embodiment

In the second embodiment, the correction currents are determined in the different way from the first embodiment, in which the drive-side correction current ΔIsol is determined indirectly by calculating it as ΔIsol=ΔIc−ΔItcu and stored in the EEPROM 4a together with the control-side correction current ΔItcu.

In the second embodiment, specifically, the operation deviation ΔPsol of the electromagnetic valve 2 relative to the actual current Ij is measured (FIG. 2C) and the drive-side correction current ΔIsol is calculated in correspondence to the measured deviation ΔPsol. This correction current ΔIsol is subtracted from the system correction current ΔIc, thus calculating the control-side correction current ΔItcu (=ΔIc−ΔIsol). This control-side correction current ΔItcu and the drive-side correction current ΔIsol are stored in the EEPROM 4a.

In the above embodiments, in which the electric drive device system is implemented for the automatic transmission 1, the electric drive device system may be implemented for other systems, which use electric drive devices such as electromagnetic valves.

Further, the electric drive device may be any electrically-operable actuators, and the operation characteristics may be compensated for by correction values of electric parameters such as a voltage.

What is claimed is:

1. An electric drive device control system comprising:
an electric drive device that operates in accordance with an electric current applied thereto; and
an electric control unit that calculates a command current to be supplied to the electric drive device by storing a system correction current and compensating for an operation deviation by the system correction current, the operation deviation being caused when the electric drive device is supplied with the electric current by the electric control device,
wherein the electric control unit is configured to
store a control-side correction current for compensating for a current deviation between the command current and the actual current supplied to the electric drive device,
store a drive-side correction current for compensating for an operation deviation of the electric drive device caused when the electric drive device is supplied with the actual current,
update the stored drive-side correction current to a new drive-side correction current, which is specific to a new electric drive device, when the electric drive device is replaced with the new electric drive device, and correct the command current for the new electric drive device by using the stored control-side correction current and the new drive-side correction current, and
update the stored control-side correction current to a new control-side correction current, which is specific to a new electric control unit, when the electric control unit is replaced with the new electric control unit, and correct the command current for the electric drive device by using the new control-side correction current and the stored drive-side correction current.

2. The electric drive device control system according to claim 1, wherein:
the electric control unit is tested before shipment to measure a current deviation between the command current and the actual current;
the control-side correction current is determined to compensate for the measured current deviation;
the drive-side correction current is calculated by subtracting the control-side correction current form the system correction current; and
the electric control unit is configured to separately store the control-side correction current and the drive-side correction current.

3. The electric drive device control system according to claim 1, wherein:
the electric drive device is tested before shipment to measure an operation deviation caused when the actual current is supplied;
the drive-side correction current is calculated to compensate for the measured operation deviation;
the control-side correction current is calculated by subtracting the drive-side correction current form the system correction current; and
the electric control unit is configured to separately store the control-side correction current and the drive-side correction current.

4. The electric drive device control system according to claim 1, wherein:
the electric drive device is an electromagnetic valve for a hydraulic pressure supply device of a vehicle automatic transmission;
the electric control unit is a transmission control unit, which electrically controls supply of current to the electromagnetic valve;
the electromagnetic valve is impaired with a data code indicating the drive-side correction current calculated therefor; and
the transmission control unit is impaired with and store therein the control-side correction current calculated specifically thereto.

5. An electric drive device control method for a control system, which includes an electric drive device operable with an electric power applied thereto, and an electric control unit for the electric drive device, the method comprising:
testing the control system before shipment to measure a system operation deviation from a predetermined system operation characteristics and determine a system correction value required to eliminate the measured system operation deviation;
testing either the electric drive device or the electric control unit before shipment to measure an operation deviation of the electric drive device or the electric control unit from a predetermined operation characteristics and determine a first correction value required to eliminate the measured operation deviation of the tested electric drive device or electric control unit,
determining a second correction value required to eliminate an operation deviation of the untested electric drive device or electric control unit, by subtracting the first correction value from the system correction value;
storing the first correction value and the second correction value separately in the electric control unit to correct the electric power applied to the electric drive device by the electric control unit; and
updating the first correction value and the second correction value to new correction values, when the electric drive device and the electric control unit are replaced with new ones, respectively, the new correction values being determined as the first correction value and the second correction value for the new ones.
